(19) United States
(12) Patent Application Publication
(10) Pub. No.: US 2003/0160001 A1
(43) Pub. Date: Aug. 28, 2003

(54) Control of encrustations of phosphate-containing double salts

(76) Inventors: Thomas Klein, Koln (DE); Harry-Gunter Muller, Bergisch Gladbach (DE)

Correspondence Address: BAYER CHEMICALS CORPORATION, 100 BAYER ROAD, PITTSBURGH, PA, 15205, US

(21) Appl. No.: 10/369,377

(22) Filed: Feb. 19, 2003

(30) Foreign Application Priority Data
Feb. 20, 2002 (DE) 10207088.1

(51) Int. Cl. C02F 1/00

(52) U.S. Cl. 210/698

(57) ABSTRACT

The present invention relates to a process for the control of encrustations of phosphate-containing double salts, characterized in that polymers having repeating succinyl units or their partial hydrolysates and/or their salts are allowed to act on encrustations of phosphate-containing double salts in stagnant or flowing waters which contain phosphate ions.

### BACKGROUND OF THE INVENTION

1. Field of the Invention

The present invention relates to a process for controlling encrustations of phosphate-containing double salts. The process is characterized in that polymers having repeating succinyl units or their partial hydrolysates and/or their salts, preferably sodium salts or potassium salts are allowed to act on encrustations of phosphate-containing double salts in stagnant or flowing waters, which contain phosphate ions, or are added to water having the potential capacity for formation of deposits from phosphate-containing double salts.

2. Brief Description of the Prior Art

In modern wastewater treatment, for example in sewage treatment plants, physical, chemical and biological processes are combined with one another. In the biological purification stage of sewage treatment plants, the objective is the conversion (mineralization) of the readily degradable organic wastewater contents to inorganic end products, (for example water, carbon dioxide, ammonium ions, nitrate ions, phosphate ions or sulphate ions) as completely as is possible. In the processes, activated sludge is added to preliminarily clarified water. Wastewater/activated sludge mixture is constantly circulated and aerated in bioreactors of the sewage treatment plants, which are activation towers and/or tanks. The sludge settles and the majority thereof is recirculated to the towers via turbine pumps, and the excess sludge is taken off.

And, finely dispersed sludge contents are brought to the surface through flotation, by outgassing air and are skimmed off.

The combined sludges from the treatments are dewatered and supplied to sludge incineration or else reprocessed in sludge digestion systems.

Also in the biological purification stage, bacteria convert high molecular weight organic soil components under anaerobic conditions to H₂S, CO₂ and intermediates such as alcohol and organic acids, which are then fed to a final breakdown stage by methane bacteria. The end products: 70% methane, 30% CO₂ in the digester gas, CO₂, NH₃ and H₂S dissolved in the digester water.

Formation of deposits in the sewage treatment plants essentially occurs owing to CO₂ outgassing, pH changes or temperature changes. These deposits are formed by degradation processes in the tower or tank biology, where the content of dissolved organic substances is considerably reduced. In the course of this, considerable amounts of carbon dioxide and ammonia are formed. As a result of the associated formation of ammonium hydrogencarbonate, a buffer system is formed (pH 6.5-7.5) in which magnesium ions and calcium ions are held in solution. Depending on the sludge concentration, the content of ammonium hydrogencarbonate can increase markedly above 5 000 mg/l.

Also, the degradation of biomass allows the concentration of phosphate ions to increase. The orthophosphate content of sludge water is expected to be according to previous experience from 25 to 100 mg/l provided that chemical phosphate precipitation has been performed. If biological phosphate elimination has been performed in advance, markedly higher values up to 1000 mg/l must be expected. The consequence thereof is that under conditions of virtually neutral pH, encrustations of phosphate-containing double salts, for example hydroxylapatite or magnesium ammonium phosphate, occur. Thus, for example, hydroxylapatite Ca₅((PO₄)₃(OH)) precipitates at a pH of approximately 8. Encrustations of this salt are preferred if the concentration not only of Ca ions (>80 mg/l) but also of the phosphate ions (>60 mg/l) is high. It precipitates out spontaneously as soon as it is in the central discharge of the centrifuge.

Deposits of magnesium ammonium phosphate, NH₄MgPO₄.6H₂O, occur under certain preconditions. In particular, during the dewatering of digester sludge, crystallization of magnesium ammonium phosphate frequently occurs and leads to problems due to deposits in the corresponding dewatering systems and subsequent piping which transports the sludge water. This phenomenon occurs particularly frequently during digester sludge dewatering using centrifuges. The crystallization generally occurs after exit of the sludge water from the centrifuge and is intensified by deposits of sludge particles, which have not separated out. During centrifugation under extreme pressure, air is dissolved with carbon dioxide in the liquid phase. Spontaneous expansion at exit from the centrifuge causes immediate release of the gas and ammonia. The resultant loss of buffer capacity causes a pH rise, causing precipitation of calcium and magnesium salts and, at phosphate concentrations >60 mg/l and pH 8, hydroxylapatite Ca₅((PO₄)₃(OH)) and, at phosphate concentrations >140 mg/l from pH 7, magnesium ammonium phosphate precipitate out.

Previous methods of dispersing or controlling phosphate precipitates in sewage treatment plants comprise the use of dilute acetic acid, phosphonic acids or the dilution of the salt-bearing water volumes and correction of pH using an acid tank.

However, the substances used have the disadvantage that, as acids, they produce aggressive conditions and, as phosphonic acids, they are not biodegradable. However, in sewage treatment plants biodegradability is of great importance, since clarified water volumes are passed into natural water systems.

The object of the pertinent art was, therefore, to find a novel scale controller for stagnant and flowing phosphate-containing waters, preferably for agriculture or sewage treatment plants, which firstly is active under gentle conditions, that is to say in the neutral pH range, preferably pH 5-8, controls as far as possible all types of deposits of phosphate-containing double salts and is also highly biodegradable.

U.S. Pat. No. 5,152,902 discloses that polyaspartic acid can be used as calcium phosphate inhibitor. EP-A 0 819 653 discloses polyasparartic acid not only as calcium phosphate encrustation inhibitor, but also as magnesium phosphate encrustation inhibitor.

### SUMMARY OF THE INVENTION

The present invention therefore relates to a process for controlling encrustations of phosphate-containing double salts in flowing and stagnant phosphate-containing waters, characterized in that polymers having repeating succinyl units or their partial hydrolysates and/or their sodium salts or potassium salts are allowed to act on encrustations of phosphate-containing double salts or are added to water potentially having the capacity for formation of deposits of phosphate-containing double salts. Polymers having repeating succinyl units or their partial hydrolysates and/or their sodium salts or potassium salts in the context of the present invention are characterized in that they contain iminodisuccinate units. The iminodissucinate units can be present as end group and/or as repeating units.

### DETAILED DESCRIPTION OF THE INVENTION

The inventively usable polymers preferably have repeating succinyl units having at least one of the following structures

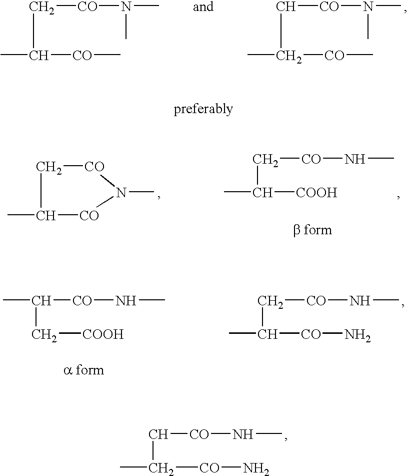

or a salt, preferably sodium salt or potassium salt, thereof.

The iminodissucinate units preferably have at least one of the following structures:

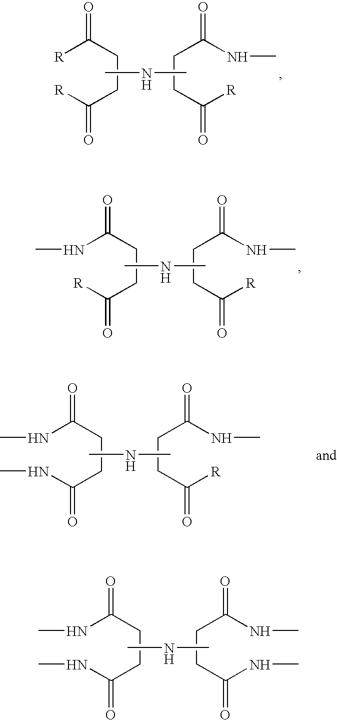

where

R represents the radicals OH, O⁻NH₄⁺ or NH₂.

The polymers to be used inventively exhibit, depending on the reaction conditions chosen in the preparation, differing chain lengths and molecular weights. Polymers which are used inventively have Mw=500 to 10 000, preferably 500 to 5 000, particularly preferably 700 to 4 500, but also the compound iminodisuccinate itself can be used in accordance with the invention. Based on the groups

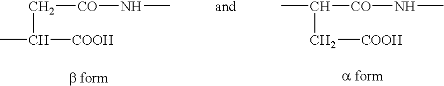

(repeating aspartic acid units), preferably at least 50%, in particular at least 70%, are present in β-linked form.

The iminodisuccinate units can be randomly distributed in the polymer or preferably are present as end group. Based on the sum of all repeating units, the iminodisuccinate unit is generally present at least 0.1 mol %. The molar ratio of the iminodisuccinate units incorporated in the polymer to the sum of all monomer units incorporated in the polymer is preferably 0.1 mol % to 99 mol %, preferably 1 mol % to 50 mol %, particularly preferably 2 mol % to 25 mol %.

Depending on the reaction conditions, during synthesis of the polymers to be used inventively having repeating succinyl units, further repeating units can be present, e.g.,

a) malic acid units of the formulae

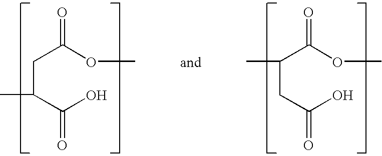

b) maleic acid and fumaric acid units of the formulae

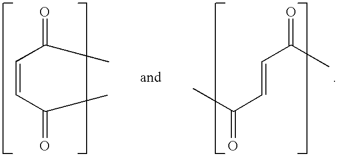

Particularly preferably in the context of the present invention, polysuccinimide (PSI) and polyasparartic acid are used against encrustations of phosphate-containing double salts.

PSI can be prepared on an industrial scale by thermal polymerization of maleic anhydride and ammonia or derivatives thereof (see U.S. Pat. No. 3,846,380, 5,219,952 or 5,371,180).

In addition, PSI is obtained by thermal polymerization of aspartic acid (U.S. Pat. No. 5,051,401).

PSI is produced in the chemical synthesis as a polymer having a mean molar weight of 500 to 20 000, preferably 3 000 to 5 000. Polysuccinimide may be considered a chemical precursor of polyaspartic acid, to which it is slowly hydrolysed with water. The pH of the resultant solution is between a pH of 1 to 4, preferably 2 to 3. As a result there comes into effect not only the good scale-dissolving action, but also simultaneously the dispersing action of the polyaspartic acid released by PSI against sparingly soluble calcium salts and other sparingly soluble substances. The resultant acidic solution leads, owing to its acidic action, also to the direct disintegration of encrustations. Especially in hard mountain waters having elevated pH and thus an intensified encrustation problem, PSI expediently exhibits an increased solubility. In addition, PSI, because of its slow hydrolysis with simultaneously low water solubility, is active for a long time at the point of use and thus markedly superior to the direct use of polyaspartic acid (slow release effect). As a result, the reformation of phosphate encrustations can be avoided over a relatively long period if PSI is used in dispersions or tablets.

The direct preparation of polyaspartic acids starting from maleic anhydride or maleic acid is described, for example, in U.S. Pat. No. 5,288,783.

To disintegrate the encrustations of phosphate-containing double salts, preferably aqueous solutions of the polymers having repeating succinyl units or their partial hydrolysates and/or their salts are used. The polymers containing repeating succinyl units or their partial hydrolysates and/or their salts are preferably employed at concentrations between 1 and 100 ppm, preferably between 2 and 10 ppm.

The encrustations to be disintegrated by means of the polymers to be used inventively having repeating succinyl units or their partial hydrolysates and/or their salts are deposits containing inorganic phosphate-containing double salts, preferably hydroxylapatite Ca₅((PO₄)₃(OH)) or magnesium ammonium phosphate NH₄MgPO₄.6H₂O.

Preference is given to the use of the polymers to be used inventively having repeating succinyl units or their partial hydrolysates and/or their salts in flowing or stagnant phosphate ion-containing waters, particularly preferably in sewage treatment plants or agricultural plants, particularly preferably in the neutral pH range, very particularly preferably at pH 5 to 8.

In a particularly preferred embodiment of the present invention, the polymers having repeating succinyl units, their partial hydrolysates, and/or their salts, preferably sodium salts or potassium salts, particularly preferably polysuccinimide, are used in the form of dispersions or tablets, in the presence or absence of other aids such as surfactants, binders, rheology modifiers or digestion inhibitors. in order to achieve a slow-release action and thus ensure maintenance-free use over a relatively long time period and prevent reformation of the encrustation of phosphate-containing double salts. The polymer are used to treat systems actually having or potentially having encrustations of phosphate-containing double salts in stagnant or flowing waters which contain phosphate ions. Illustratively, the polymers are allowed to act on the encrustation by contact, or are added to water having the potential for formation of deposits from phosphate-containing double salts.

The inventive use of the polymers having repeating succinyl units or their partial hydrolysates and/or their salts, preferably polyaspartic acid, its sodium salt (PASP) or PSI to control deposits of phosphate-containing double salts in sewage treatment plants may be illustrated by the following examples:

The invention is further illustrated but is not intended to be limited by the following examples in which all parts and percentages are by weight unless otherwise specified.

### EXAMPLES

### Example 1

Solution 1 Diammonium Hydrogenphosphate and Ammonia Water, each 0.2 Molar,

Solution 2 0.2 M Magnesium Chloride Solution.

10 ml of Solution 1 and 80 ml of distilled H₂O were introduced. Before 10 ml of Solution 2 were pumped in, the pH was adjusted with HCl to pH=7. A precipitate of magnesium ammonium phosphate (“MAP”) begins to fall.

This solution was kept in closed flasks at room temperature overnight, without or with addition of 10 or 100 ppm of the sodium salt of polyaspartic acid (PASP).

Next morning, 5 ml of the solution were removed with a syringe, filtered and magnesium ions in solution were back-titrated with 0.1 M Titriplex solution.

Consumption:

Consumption:

| Without addition | 10 ppm PASP | 100 ppm PASP |
|---|---|---|
| 0.454 mmol | 0.768 mmol | 0.796 mmol |

Original amount in the 5 ml: 1 mmol

Original amount in the 5 ml: 1 mmol

It was found therefrom that the magnesium hardness on storage at room temperature was approximately 70% higher on addition of PASP.

### Example 2

Solution 1 Diammonium Hydrogenphosphate and Ammonia Water, each 0.2 Molar,

Solution 2 0.2 M Calcium Chloride Solution

10 ml of Solution 1 and 80 ml of distilled H₂O were introduced. Before pumping in 10 ml of Solution 2, the pH was set to pH 8. A precipitate of hydroxylapatite (HAP) begins to fall.

This solution was kept overnight in closed flasks at room temperature without or with addition of 10 or 100 ppm of the sodium salt of polyaspartic acid (PASP).

Next morning, 5 ml of the solution were removed with a syringe, filtered and calcium ions in solution were back-titrated with 0.1 M Titriplex solution.

Consumption:

Consumption:

| Without addition | 10 ppm PASP | 100 ppm PASP |
|---|---|---|
| 0.374 mmol | 0.801 mmol | 0.884 mmol |

Original amount in the 5 ml: 1 mmol

It was found therefrom that the calcium hardness on storage at room temperature was about 115% higher with addition of PASP.

### Example 3

A piece of a well crystallized deposit of MAP from a municipal sewage treatment plant was placed in a dispersion of PSI for 2 days with stirring.

Initial weight: 11.29 g

After 2 days: 7.45 g

This corresponds to a weight decrease of 3.84 g, or 34%.

### Example 4

In a municipal sewage treatment plant, the encrustation due to magnesium ammonium phosphate was followed using 4 7 cm stainless steel and aluminium sheets which had been suspended in the central circuit (downstream of sludge separation via a centrifuge). The weight increase of the metal strips due to magnesium ammonium phosphate was 0.8 g within a period of 10 days.

By adding the inventive polymers (having repeating succinyl units) in an amount of 26 ppm, the formation of deposits within the 10-day window was decreased to approximately 0.05 g of magnesium ammonium phosphate.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for controlling encrustations of phosphate-containing double salts from stagnant or flowing phosphate ion-containing waters, comprising allowing polymers containing repeating succinyl units, their partial hydrolysates and/or their salts to act on the encrustation.

2. Process according to claim 1, wherein the polymers are polyaspartic acid or polysuccinimide and/or salts thereof are used.

3. Process according to claim 1, wherein the polymers containing repeating succinyl units, their partial hydrolysates and/or their salts, are employed in concentrations between 1 and 100 ppm.

4. Process according to claim 1, wherein the encrustations contain hydroxylapatite or magnesium ammonium phosphate.

5. Process for avoiding the reformation of encrustations of phosphate-containing double salts, comprising providing polysuccinimide or polyaspartic in instance when there had been prior removal of the encrustations.

6. Process according to claim 1, wherein the polysuccinimide or polyaspartic is used in the form of a dispersion or tablet.

7. Process according to claim 5, wherein the polysuccinimide or polyaspartic is used in the form of a dispersion or tablet.
